(19) United States
(12) Patent Application Publication
(10) Pub. No.: US 2026/0009526 A1
(43) Pub. Date: Jan. 8, 2026

(54) ADJUSTABLE LIGHT STAND

(71) Applicant: TILTA INC., Burbank, CA (US)

(72) Inventors: Sen WU, Shenzhen (CN); Wenping ZENG, Shenzhen (CN); Kefeng ZHOU, Shenzhen (CN)

(21) Appl. No.: 19/261,380

(22) Filed: Jul. 7, 2025

(30) Foreign Application Priority Data
Jul. 8, 2024 (CN) 2024216126051

(51) Int. Cl. F21V 21/22; F21V 21/15; F21V 33/00

(52) U.S. Cl. CPC F21V 21/22; F21V 21/15; F21V 33/0052

(57) ABSTRACT

The present disclosure pertains to the field of photographic equipment, specifically to an adjustable light stand, including: a mounting frame, on which a connector is movably mounted, and the connector is provided with a mounting position for installing a light fixture; and a first locking assembly, disposed on either the mounting frame or the connector, for locking or unlocking the connector and the mounting frame.

### CROSS-REFERENCE TO RELATED APPLICATIONS

The present application for patent claims priority to and the benefit of pending Chinese Application No. 2024216126051, filed Jul. 8, 2024, and hereby expressly incorporated by reference herein as if fully set forth below in its entirety and for all applicable purposes.

### TECHNICAL FIELD

The present disclosure pertains to the field of photographic equipment, specifically to an adjustable light stand.

### INTRODUCTION

During the photographic process, multiple lights are often used in combination to achieve the desired shooting effects. The installation and support of these lights are typically accomplished through lamp stands. Existing lamp stands generally consist of two arms, with lights installed between them for support. However, to accommodate lights of various sizes and models during photography, multiple light stands are often required, leading to increased costs and greater space usage, which inadequately meets the photographic needs of photographers.

For example, a shooting support frame may include a support frame body and a light source. The light source is mounted on the support frame body, which includes a vertically arranged support section, a connecting section extending horizontally from the top end of the support section, and a light box connected to the front end of the connecting section, with the light source being installed in the light box. The support frame body disclosed in this prior application exhibits the same defects as those in the existing technology mentioned above.

### BRIEF SUMMARY

To address the aforementioned issues, aspects of the present disclosure provide an adjustable light stand capable of adjusting its height to accommodate lights of various sizes and models.

In some aspects, the technical solution of the present disclosure are as follows:

An adjustable light stand including:
a mounting frame, on which a connector is movably mounted; the connector is provided with a mounting position for installing a light fixture;
a first locking assembly, disposed on either the mounting frame or the connector, for locking or unlocking the connector and the mounting frame.

### BRIEF DESCRIPTION OF THE DRAWINGS

FIG. 1 is a diagram illustrating a light stand for a light fixture according to some aspects of the disclosure.

FIG. 2 is a diagram illustrating the light stand with a cover plate hidden according to some aspects of the disclosure.

FIG. 3 is an exploded view of a cover plate, a gear, and a gear rack according to some aspects of the disclosure.

FIG. 4 is a partially enlarged view of an area A in FIG. 2 according to some aspects of the disclosure.

FIG. 5 is an exploded view of a first frame section and a connector according to some aspects of the disclosure.

FIG. 6 is a cross-sectional view of the first frame section and the connector according to some aspects of the disclosure.

FIG. 7 is a diagram illustrating a first locking assembly according to some aspects of the disclosure.

FIG. 8 is an exploded view of the light stand and the light fixture according to some aspects of the disclosure.

### LEGEND

1. light stand; 11. mounting position; 111. slide rail; 112. locking groove; 12. mounting frame; 121. mounting socket; 122. locking access port; 123. positioning hole; 124. first frame section; 125. second frame section; 126. connecting segment; 13. connector; 131. support leg; 132. spring-loaded detent; 14. first locking assembly; 141. control lever; 142. first locking element; 1421. actuating rod; 1422. locking part; 1423. locking surface; 143. return spring; 15. central hub; 151. locking window; 152. mounting port; 153. cover plate; 154. column spinner; 16. drive assembly; 161. gear; 162. gear rack; 17. second locking assembly; 171. pressure plate; 172. second locking element; 173. pressure pin; 1721. first clamping lever; 1722. rotating shaft; 1723. eccentric articulating part;
2. light fixture; 21. sliding groove; 22. second clamping lever; 23. eccentric cam head.

### DETAILED DESCRIPTION

To make the objectives, technical solutions, and aspects of the present disclosure clearer, the following detailed description is provided in conjunction with the accompanying drawings and embodiments. It should be understood that the specific embodiments described herein are merely for illustrative purposes and do not limit the scope of the present disclosure.

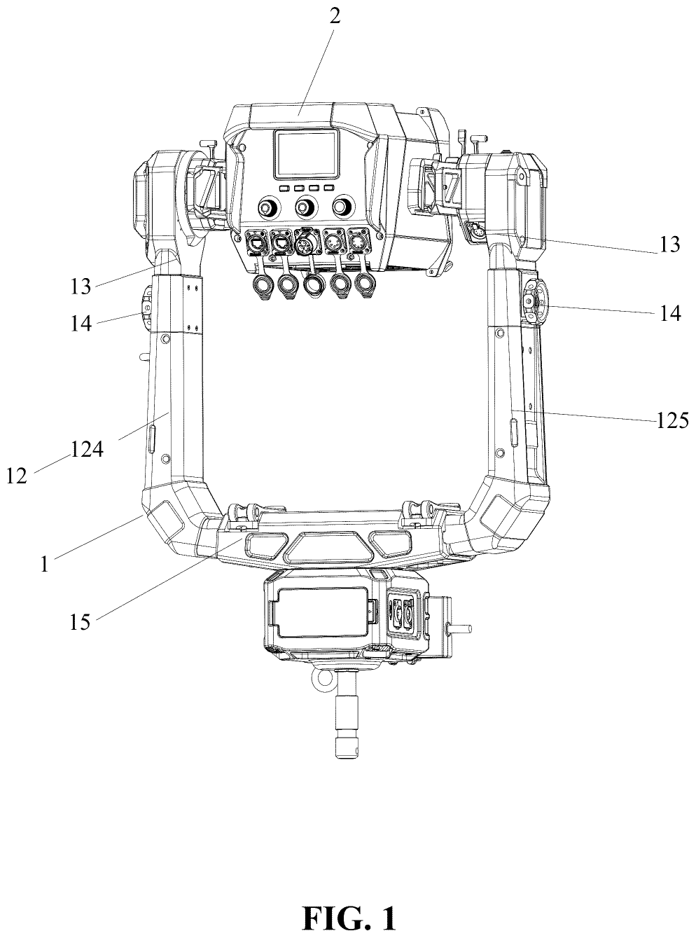

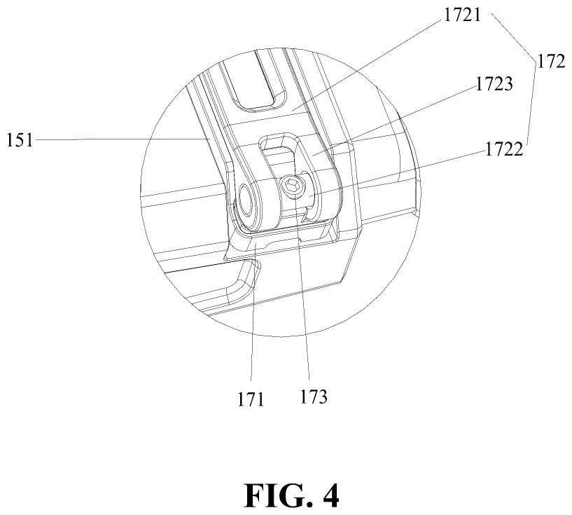

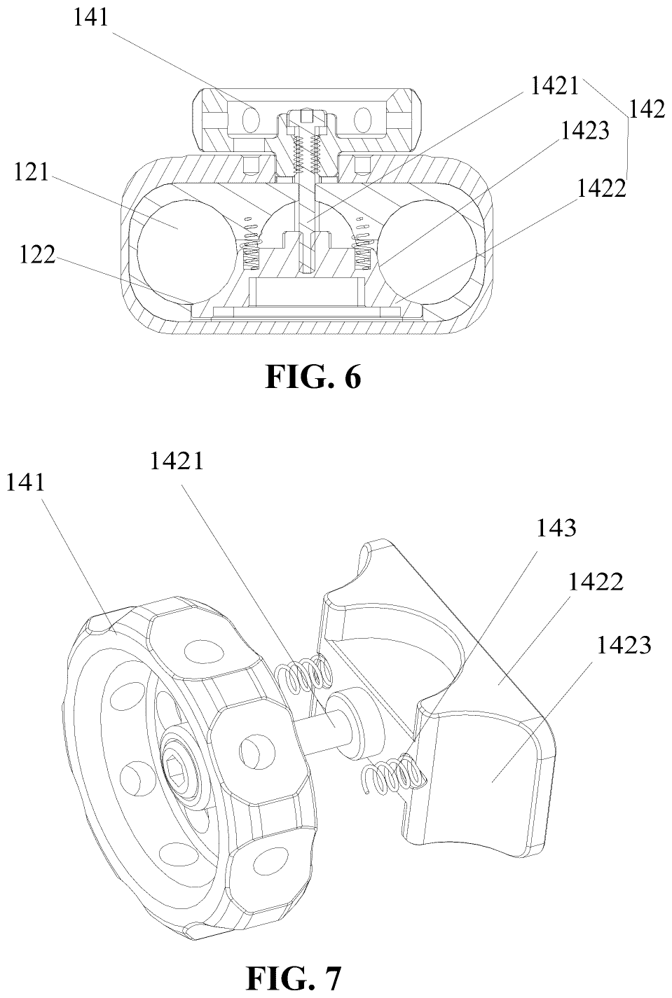

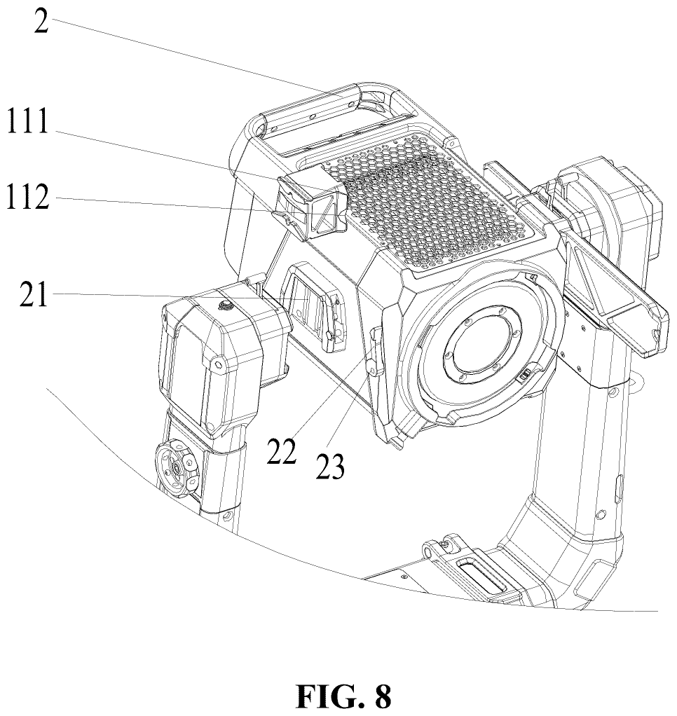

Referring to FIGS. 1-8, aspects of the disclosure provide an adjustable light stand 1, including:
a mounting frame 12, on which a connector 13 is movably mounted, and the connector 13 is provided with a mounting position 11 for installing a light fixture 2; and
a first locking assembly 14, disposed on the mounting frame 12, for locking or unlocking the connector 13 and the mounting frame 12.

The first locking assembly 14 is provided to lock and fix the mounting frame 12 and the connector 13 after adjustment. When the height of the light stand 1 needs to be adjusted again, the first locking assembly 14 can unlock the mounting frame 12 and the connector 13, allowing the mounting frame 12 and the connector 13 to continue relative telescoping movement and enabling repeated height adjustments of the light stand 1.

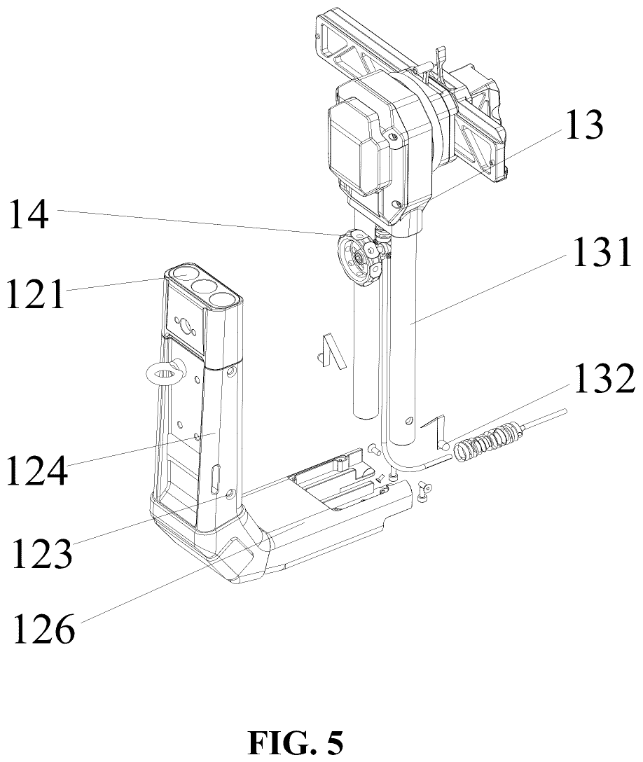

Referring to FIGS. 5-7, in some aspects, the mounting frame 12 is provided with mounting sockets 121, and the connector 13 is telescopically and movably inserted into the mounting sockets 121. This cooperation between the mounting sockets 121 and the connector 13 enhances the stability of the connector's movement relative to the mounting frame. Alternatively, in other implementations, the connector 13 can be provided with sockets, and the mounting frame 12 can be telescopically and movably inserted into the sockets of the connector 13.

In some aspects, the first locking assembly 14 is movably mounted on the mounting frame 12 and corresponds to the connector 13. By moving on the mounting frame 12, the first locking assembly 14 can lock the connector 13 to the mounting frame 12 and unlock the locked mounting frame 12 and connector 13 for relative movement.

In some aspects, the first locking assembly 14 includes a control lever 141 and a first locking element 142. The first locking element 142 is disposed at the mounting socket 121 and connected to the control lever 141 to control the locking and unlocking of the connector 13 by the first locking element 142.

In some aspects, there are two mounting sockets 121, and the connector 13 includes two support legs 131, which are respectively telescopically and movably inserted into the two mounting sockets 121. Locking access ports 122 can be provided on the sides of both mounting sockets 121. The first locking element includes an actuating rod 1421 and a locking part 1422 connected to the actuating rod 1421. Locking surfaces 1423 for locking the connector 13 can be provided on both sides of the locking part 1422, corresponding to the locking access ports 122 of the two mounting sockets 121. The control lever 141 is located outside the mounting frame 12. One end of the actuating rod 1421, opposite the locking part 1422, passes through the mounting frame 12 and movably connects to the control lever 141 via threaded engagements. By rotating the control lever 141, the actuating rod 1421 is driven to move the locking part 1422, causing the locking surfaces 1423 on both sides of the first locking element 142 to engage with or disengage from the two support legs 131 through the two mounting sockets 121, thereby locking or unlocking the connector 13 and the mounting frame 12. In some aspects, the control lever 141 can be a knob or a wrench with an eccentric cam head, and a bushing can be provided between the control lever 141 and the actuating rod 1421.

In some aspects, a return spring 143 is provided between the locking access port 122 and the first locking element 142.

In some aspects, a spring-loaded detent 132 is provided on the connector 13, and multiple positioning holes 123 can be provided on the mounting frame 12, corresponding to the spring-loaded detent 132. During telescoping movement of the mounting frame 12 and the connector 13, preliminary positioning can be achieved through the cooperation of the spring-loaded detent 132 and the positioning holes 123. After positioning, the first locking assembly 14 can be used to lock the positions of the mounting frame 12 and the connector 13. When further adjustment is needed, the first locking element 142 is first moved to unlock the mounting frame 12 and the connector 13. Then, by pressing the spring-loaded detent 132 to disengage it from the positioning hole 123, telescoping adjustment of the mounting frame 12 and the connector 13 can be performed.

Referring to FIGS. 1, 2, and 8, in some aspects, connectors 13 can be movably mounted at both ends of the mounting frame 12. The first locking assembly 14 includes multiple units, with two of them being movably mounted at both ends of the mounting frame 12. When installing the light fixture 2, it is connected to the mounting positions 11 on both connectors 13 of the mounting frame 12, supported by the two connectors 13. The light fixture 2 is located between the mounting positions 11 of the two connectors 13. The connection method between the mounting position 11 and the light fixture 2 can include common connection methods known in the field, such as threaded connection or sliding groove and slide rail connection. The present embodiment uses the sliding groove and slide rail connection as an example. In the present embodiment, the light fixture 2 includes a sliding groove 21 provided on its sidewall, and the mounting position 11 includes a slide rail 111 that slides within the sliding groove 21. The sidewall of the light fixture 2 may also include a second clamping lever 22 with an eccentric cam head 23 for locking the slide rail 111. When the second clamping lever 22 is operated, its eccentric cam head 23 moves towards the sliding groove 21 to lock the slide rail 111, thereby installing and securing the light fixture 2. More specifically, the slide rail 111 has a locking groove 112, and the eccentric cam head 23 of the second clamping lever 22 can press against the locking groove 112.

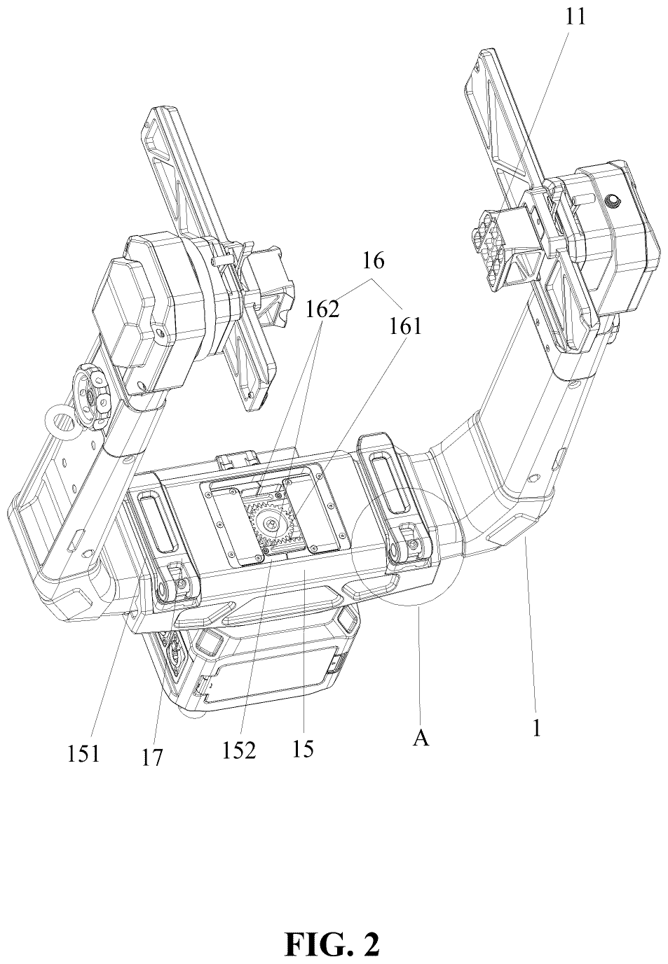

Referring to FIGS. 2-4, in some aspects, the mounting frame 12 includes a first frame section 124, a second frame section 125, and a central hub 15. Connectors 13 can be movably mounted at the opposing ends of the first frame section 124 and the second frame section 125, respectively. The adjacent ends of the first frame section 124 and the second frame section 125 are both bent to form two connecting segments 126 (see FIG. 5 for one example). These two connecting segments 126 can be telescopically and movably connected via the central hub 15. The connecting segments 126 can move within the central hub 15 for telescopic adjustment, thereby controlling the distance between the two connectors 13 and enabling the light stand 1 to accommodate light fixtures (e.g., light fixture 2) of various sizes and specifications.

In some aspects, a drive assembly 16 can be disposed within the central hub 15 to facilitate the simultaneous telescopic movement of the two connecting segments 126 (a first connecting segment and a second connecting segment) within the central hub 15. The drive assembly 16 is connected to both connecting segments 126. The configuration of the drive assembly 16 ensures synchronized movement of the two connecting segments 126 within the central hub 15, thereby maintaining the symmetry of the two connectors 13 and enhancing the balance of the light stand I during use.

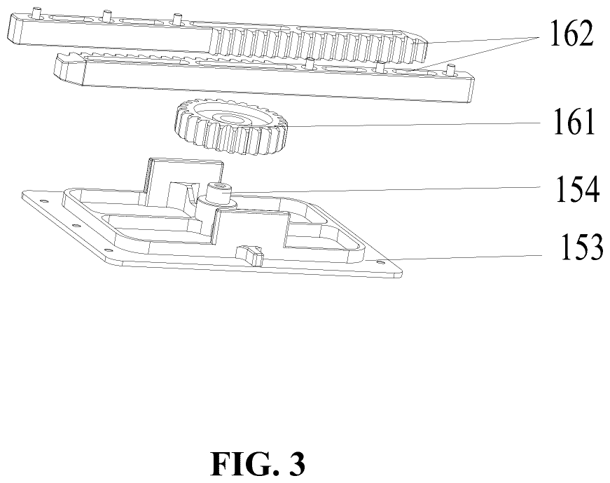

In some aspects, the drive assembly 16 includes a gear 161 and two gear racks 162. The gear 161 is rotatably mounted within the central hub 15. Each gear rack 162 is connected to one of the connecting segments 126 and meshes with opposite sides of the gear 161. As a result, when the two connecting segments 126 move within the central hub 15, their movement is synchronized through the engagement of the two gear racks 162 with the gear 161, ensuring better consistency in their movement. In some aspects, the central hub 15 is provided with a mounting port 152, where a removable cover plate 153 (see FIG. 3) is installed. A column spinner 154 is disposed on the cover plate 153, and the gear 161 is rotatably sleeved onto the column spinner 154. The gear 161 can be installed into or removed from the central hub 15 through the mounting port 152 by disassembling or assembling the cover plate 153.

In some aspects, the central hub 15 is equipped with two second locking assemblies 17 for respectively locking or unlocking the two connecting segments 126. Each second locking assembly 17 corresponds to one connecting segment 126. Following the adjustment of the two connecting segments 126, their positions can be locked by the two second locking assemblies 17. When further adjustment is required, the two second locking assemblies 17 can also unlock the two connecting segments 126.

In some aspects, each second locking assembly 17 includes a pressure plate 171, a second locking element 172, and a pressure pin 173. The central hub 15 is provided with a locking window 151 that exposes the connecting segment 126. The pressure plate 171 is positioned at the locking window 151, and the pressure pin 173 is threadedly mounted on the central hub 15. By rotating the pressure pin 173 to different positions, the locking tightness of the second locking assembly 17 can be adjusted. The end of the pressure pin 173 away from the central hub 15 extends through the pressure plate 171 to movably connect with the second locking element 172, while the end of the pressure plate 171 away from the pressure pin 173 is fixed to the central hub 15.

The second locking element 172 includes a first clamping lever 1721 and a rotating shaft 1722. The first clamping lever 1721 is provided with an eccentric articulating part 1723. The pressure pin 173 extends through the pressure plate 171 to movably connect with the rotating shaft 1722, and the eccentric articulating part 1723 is hinged to the rotating shaft 1722. During locking, the first clamping lever 1721 is rotated, causing the eccentric articulating part 1723, which has an eccentric structure, to press down on the pressure plate 171. This enables the pressure plate 171 to abut against the connecting segment 126. When unlocking is required, the first clamping lever 1721 can be rotated in the opposite direction.

The above descriptions represent exemplary embodiments of the present disclosure and should not be construed as limiting the scope of the present disclosure. Any modifications, equivalent substitutions, and improvements made within the spirit and principles of the present disclosure shall fall within the protection scope of the present disclosure.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. An adjustable light stand, comprising:
a mounting frame;
a connector is movably provided on the mounting frame, the connector being provided with a mounting position configured to install a light fixture; and
a first locking assembly, provided on the mounting frame or the connector to selectively lock or unlock the connector with respect to the mounting frame.

2. The adjustable light stand according to claim 1, further comprising:
a plurality of first locking assemblies movably provided at respective ends of the mounting frame,
wherein the connector comprises a first connector and a second connector movably provided at the respective ends of the mounting frame.

3. The adjustable light stand according to claim 1, wherein the mounting frame is provided with one or more mounting sockets, and the connector is movably provided in the one or more mounting sockets; and
wherein the first locking assembly is movably provided on the mounting frame.

4. The adjustable light stand according to claim 1, wherein the connector is provided with one or more mounting sockets, and the mounting frame is movably provided in the one or more mounting sockets; and
wherein the first locking assembly is movably provided on the connector.

5. The adjustable light stand according to claim 3, wherein the first locking assembly comprises a control lever and a first locking element;
wherein the first locking element is movably provided at the one or more mounting socket; and
wherein the control lever is connected to the first locking element to enable the first locking element to lock the connector in a secured position and to unlock the connector from the secured position.

6. The adjustable light stand according to claim 5, wherein the first locking element comprises an actuating rod and a locking part connected to the actuating rod;
wherein a locking access port is provided on one side of the mounting socket, the locking part is provided with a locking surface configured to lock the connector, and the locking surface corresponds to the locking access port; and
wherein the control lever is located outside the mounting frame, and one end of the actuating rod, opposite the locking part, is connected to the control lever.

7. The adjustable light stand according to claim 1, wherein a spring-loaded detent is provided within the connector, and one or more positioning holes are provided on the mounting frame; and
wherein the spring-loaded detent is configured to be accommodated within one of the one or more positioning holes.

8. The adjustable light stand according to claim 2, wherein the mounting frame comprises a first frame section, a second frame section, and a central hub;
wherein first connector and the second connector are movably provided at opposite ends of the first frame section and the second frame section, respectively; and
wherein adjacent ends of the first frame section and the second frame section are bent to form two connecting segments, respectively, that are movably connected via the central hub.

9. The adjustable light stand according to claim 8, wherein the central hub is provided with a drive assembly configured to enable simultaneous telescoping movement of the first connecting segment and the second connecting segment within the central hub, and the drive assembly is connected to both the first connecting segment and the second connecting segment.

10. The adjustable light stand according to claim 9, wherein the drive assembly comprises a gear and two gear racks;
wherein the gear is rotatably provided within the central hub; and
wherein the two gear racks are respectively connected to the first connecting segment and the second connecting segment, and engage with opposite sides of the gear.

11. The adjustable light stand according to claim 8, wherein the central hub is provided with two second locking assemblies configured to lock or unlock the first connecting segment and the second connecting segment; and
wherein the two second locking assemblies respectively correspond to the first connecting segment and the second connecting segment.

12. The adjustable light stand according to claim 11, wherein each of the second locking assemblies comprises a pressure plate, a second locking element, and a pressure pin;
wherein the central hub is provided with a locking window configured to expose the connecting segment;
wherein the pressure plate is provided at the locking window;
wherein the pressure pin is provided on the central hub, and a first end of the pressure pin, opposite the central hub, passes through the pressure plate to be movably connected to the second locking element; and
wherein a second end of the pressure plate, opposite the pressure pin, is fixed to the central hub.
